(19) United States
(12) Patent Application Publication
(10) Pub. No.: US 2018/0169854 A1
(43) Pub. Date: Jun. 21, 2018

(54) CALIBRATION DEVICE AND ROBOT SYSTEM USING SAME

(71) Applicant: MITSUBISHI ELECTRIC CORPORATION, Chiyoda-ku (JP)

(72) Inventor: Koji SHIRATSUCHI, Chiyoda-ku (JP)

(73) Assignee: MITSUBISHI ELECTRIC CORPORATION, Chiyoda-ku (JP)

(21) Appl. No.: 15/737,372

(22) PCT Filed: Jun. 15, 2016
(86) PCT No.: PCT/JP2016/067793

§ 371 Date: Dec. 18, 2017

(30) Foreign Application Priority Data
Jun. 22, 2015 (JP) 2015-124837

(51) Int. Cl. B25J 9/10; B25J 9/04; B25J 18/04; B25J 11/00

(52) U.S. Cl. CPC B25J 9/10; B25J 11/0095; B25J 18/04; B25J 9/042

(57) ABSTRACT

A calibration unit includes: an approximate curve generation unit configured to generate an approximate curve based on position information and force information obtained when a tool part is rotated in accordance with an attitude command value; a bias value estimation unit configured to estimate the bias value of the force information based on the approximate curve, the position information, and the force information; a mass/center-of-gravity position estimation unit configured to remove the bias value from the force information, and to calculate a mass and a center-of-gravity position vector of the hand tip load based on the obtained force information; and an external force component calculation unit configured to subtract the bias value and the gravity action component of the hand tip load from the force information based on the bias value, and the mass and the center-of-gravity position vector.

### TECHNICAL FIELD

The present invention relates to a calibration device configured to extract only an external force generated by an external action independently of an attitude and an operation of a robot hand tip in, for example, a robot to which force control is applied, and to a robot system using the calibration device.

### BACKGROUND ART

The calibration device is configured to carry out a calibration operation for a mechanical device such as an automatic machining device, an automatic assembly device, or a robot, and to carry out gravity compensation for a hand tip load relating to a device with a mass, for example, an end effector, which acts on a provided work subject.

For example, in a robot provided with a load cell or a force sensor between the hand tip load and a robot arm, for the purposes of gravity compensation and compensation for an inertial force, external forces generated by external actions are extracted by measuring or estimating the mass and the center-of-gravity position of the hand tip load before work, calculating a gravity or inertial forces in accordance with an attitude or an acceleration/deceleration operation of the hand tip load based on those values, and subtracting the gravity or the inertial forces from a value obtained by the force sensor.

There is proposed a calibration device for measuring a position/attitude of a hand tip flange of a robot or a robot hand tip under a condition in which an external load other than a hand tip load does not act, measuring force information having six degrees of freedom containing three axial forces and three moments with a force sensor in the position/attitude, and estimating an offset voltage by the least squares method from a difference in force sensor output caused by a hand tip load during a change from one attitude to another attitude (e.g., refer to Patent Literature 1).

Moreover, there is proposed a calibration device for, in consideration of an error in a gravity direction due to a defect in an installation position, carrying out predetermined calculation from force information obtained in a plurality of attitudes, thereby obtaining by the least squares method values to be subtracted when external forces are extracted, for example, a gravity direction vector, a hand tip load weight, a center-of-gravity position vector of a hand tip load, and a bias value of a force sensor (e.g., refer to Patent Literature 2).

### CITATION LIST

### Patent Literature

[PTL 1] JP 07-205075 A
[PTL 2] JP 2012-40634 A

### SUMMARY OF INVENTION

### Technical Problem

As disclosed in Patent Literature 1 and Patent Literature 2, in a calibration device, it is important to precisely remove an offset output and a bias output generated when the sensor is installed to precisely estimate the weight and the center-of-gravity position of the hand tip load.

In the calibration devices disclosed in Patent Literature 1 and Patent Literature 2, it is assumed that unnecessary external forces do not act on the acquired data. However, in a robot actually used, wires such as communication cables and signal lines mounted to a tool part are often included as external force actions around the hand tip load mounted at a tip of the force sensor. As a result, calibration cannot be carried out precisely.

In particular, when the method of calculating respective parameters from the data acquired at a plurality of arbitrary attitudes by the least squares method and the like is used, data containing components caused by the external forces due to the cables and the like and data not containing such components are mixed with each other, and hence the bias value components cannot be estimated precisely particularly when the hand tip load is low. As a result, there is a problem in that estimation of the hand tip load mass and the center-of-gravity position vector are not precise, and hence the calibration cannot be carried out precisely.

The present invention has been made in view of the above-mentioned problem, and therefore has an object to provide a calibration device capable of removing bias components in consideration of an influence of external forces and precisely calculating a hand tip load mass and a center-of-gravity position vector, thereby carrying out calibration precisely.

### Solution to Problem

According to one embodiment of the present invention, there is provided a calibration device, which is configured to extract, in a mechanical device configured to carry out force control of a tool part, which is mounted to a tip of the mechanical device and configured to act on a work subject, only an external force generated in the tool part by contact with the work subject, the calibration device including: a position information acquisition unit configured to acquire position information on the tool part; a force information acquisition unit configured to acquire force information on a force acting on the tool part; a rotation axis specification unit configured to specify an arbitrary rotation axis passing through an origin of a sensor coordinate system; an attitude generation unit configured to generate an attitude command value for rotating the tool part about the arbitrary rotation axis; and a calibration unit configured to carry out calibration processing of subtracting a bias value and a gravity action component of a hand tip load from the force information, to thereby extract only the external force generated by the contact with the work subject, in which the calibration unit includes: an approximate curve generation unit configured to generate an approximate curve based on the position information and the force information that are obtained when the tool part is rotated in accordance with the attitude command value; a bias value estimation unit configured to estimate the bias value of the force information based on the approximate curve, the position information, and the force information; a mass/center-of-gravity position estimation unit configured to remove the bias value from the force information, and to calculate a mass and a center-of-gravity position vector of the hand tip load through use of the force information from which the bias value is removed; and an external force component calculation unit configured to subtract the bias value and the gravity action component of the hand tip load from the force information through use of the estimated bias value, and the mass and the center-of-gravity position vector of the hand tip load.

According to the one embodiment of the present invention, there is provided the calibration device, which is configured to extract, in the mechanical device configured to carry out the force control of the tool part, which is mounted to the tip of the mechanical device and configured to act on the work subject, only the external force generated in the tool part by the contact with the work subject, the calibration device including: the position information acquisition unit configured to acquire the position information on the tool part; the force information acquisition unit configured to acquire the force information on the force acting on the tool part; the rotation axis specification unit configured to specify the arbitrary rotation axis passing through the origin of the sensor coordinate system; the attitude generation unit configured to generate the attitude command value for rotating the tool part about the arbitrary rotation axis; and the calibration unit configured to carry out the calibration processing of subtracting the bias value and the gravity action component of the hand tip load from the force information, to thereby extract only the external force generated by the contact with the work subject, in which the calibration unit includes: the approximate curve generation unit configured to generate the approximate curve based on the position information and the force information that are obtained when the tool part is rotated in accordance with the attitude command value; the bias value estimation unit configured to estimate the bias value of the force information based on the approximate curve, the position information, and the force information; the mass/center-of-gravity position estimation unit configured to remove the bias value from the force information, and to calculate the mass and the center-of-gravity position vector of the hand tip load through use of the force information from which the bias value is removed; and the external force component calculation unit configured to subtract the bias value and the gravity action component of the hand tip load from the force information through use of the estimated bias value, and the mass and the center-of-gravity position vector of the hand tip load.

Therefore, it is possible to remove the bias components in consideration of the influence of external forces and precisely calculate the hand tip load mass and the center-of-gravity position vector, thereby carrying out calibration precisely.

### BRIEF DESCRIPTION OF DRAWINGS

FIG. 1 is a configuration diagram for illustrating a robot system to which a calibration device according to a first embodiment of the present invention is applied.

FIG. 2 is a block configuration diagram for illustrating the calibration device according to the first embodiment of the present invention.

FIG. 3 is an explanatory diagram for illustrating an example of a positional relationship among a robot coordinate system, a world coordinate system, a gravity coordinate system, and a sensor coordinate system of the robot system according to the first embodiment of the present invention.

FIG. 4 is an explanatory diagram for illustrating an example of a positional relationship between a mechanical flange coordinate system and the sensor coordinate system of the robot system according to the first embodiment of the present invention.

FIG. 5 is a block configuration diagram for illustrating a calibration unit of the calibration device according to the first embodiment of the present invention, and the robot system using the calibration device.

FIG. 6 is a block configuration diagram for illustrating in detail a parameter estimation unit included in the calibration unit of the calibration device according to the first embodiment of the present invention.

FIG. 7A and FIG. 7B are explanatory diagrams for illustrating an example of an operation in accordance with an attitude command value generated by an attitude-on-specified-axis generation unit in the calibration device according to the first embodiment of the present invention.

FIG. 8 is an explanatory diagram for illustrating a bias estimation operation for axial forces by a bias value estimation unit of the parameter estimation unit in the calibration device according to the first embodiment of the present invention.

FIG. 9 is an explanatory diagram for illustrating a bias estimation operation for a moment by the bias value estimation unit of the parameter estimation unit in the calibration device according to the first embodiment of the present invention.

FIG. 10 is a flowchart for illustrating processing of determining, by the bias value estimation unit of the parameter estimation unit, whether or not a bias estimation result is at a predetermined error level in a calibration device according to a second embodiment of the present invention.

FIG. 11A and FIG. 11B are explanatory diagrams for illustrating examples of a case in which the bias value estimation unit of the parameter estimation unit determines whether or not the bias estimation result is at the predetermined error level in the calibration device according to the second embodiment of the present invention.

FIG. 12 is an explanatory diagram for illustrating an example of a case in which information is displayed to a user for selection of error data by an error information display unit before the information is input to the calibration unit in the calibration device according to the second embodiment of the present invention.

FIG. 13 is an explanatory diagram for illustrating a specific example in which the calibration unit considers influence of a mass relating to a tool part and carries out offset holding of holding a contact state at the start of work in a calibration device according to a third embodiment of the present invention.

FIG. 14 is a block configuration diagram for illustrating the calibration unit of the calibration device according to the third embodiment of the present invention.

### DESCRIPTION OF EMBODIMENTS

A description is now given of a calibration device and a robot system using the calibration device according to preferred embodiments of the present invention referring to the accompanying drawings. Throughout the drawings, like or corresponding components are denoted by like reference numerals to describe those components.

In the following respective embodiments, a description is specifically given of, as an example of a calibration device, a robot system for carrying out calibration processing in a system using a robot. However, the calibration device according to the present invention can carry out the calibration with the same configuration for a mechanical device for carrying out force control even in a case where a robot is not used, and hence the scope of application of the calibration device is not limited to the robot system.

Specifically, as the calibration device, there may be given a calibration device for carrying out the calibration for a mechanical device for carrying out automatic machining or automatic assembly, for example, an automatic machining device, an automatic assembly device, and a robot, and for carrying out force control.

Moreover, the calibration device according to the present invention generates an approximate curve based on hand tip load position information and force information, which is output information of a force sensor, on the robot that are obtained when an attitude change is generated about an arbitrary axis passing through an origin of a sensor coordinate system. Moreover, from the approximate curve, the position information, and the force information, the calibration device removes unnecessary external force components that are caused by tensile forces and repulsive forces due to cables, springs, and the like, and are unnecessary for the calibration processing to estimate bias values, removes the bias values from force sensor data, then estimates a hand tip load mass and a center-of-gravity position vector, and carries out gravity compensation for the hand tip load based on those pieces of information, thereby calculating external force components acting on the hand tip load.

As a result, after the bias values are estimated from the extracted data from which data containing unnecessary external force components are removed, through estimation of the hand tip load mass and the center-of-gravity position vector, influence of the external forces contained in a plurality of pieces of input information used for estimation processing for the hand tip load mass and the center-of-gravity position vector can be removed from the acquired data, and the gravity compensation and external force component estimation can be carried out precisely.

### First Embodiment

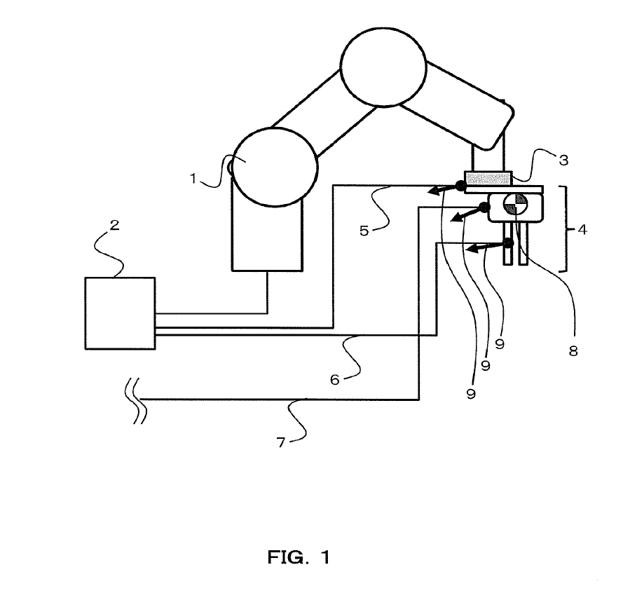

FIG. 1 is a configuration diagram for illustrating a robot system to which a calibration device according to a first embodiment of the present invention is applied. First, a description is given of details of processing of the calibration device. In FIG. 1, the robot system includes a robot arm 1, a robot controller 2, and a tool part 4 mounted to the robot arm 1 as basic components.

Moreover, a force sensor 3 is provided between the robot arm 1 and the tool part 4 as a force information sensor for acquiring force information in the robot system for carrying out the force control. In general, the robot is configured to apply position control to a tip position of the robot arm 1 or a tip position of the tool part 4 mounted to the tip of the robot arm 1, thereby moving the tip positions to a desired position specified by the controller 2 in an arbitrary coordinate system.

When force control using the force sensor 3 is introduced, impedance control and force control can be implemented in addition to the position control. Moreover, the impedance control and the force control are described later, and are control methods of passively or actively controlling a contact state, namely, an action state of a force between the tool part 4 and a peripheral environment or a peripheral object.

Work that require consideration of the contact state, for example, polishing work, deburring work, assembly work for connectors and the like, and fit work between a tapered shaft and a hole, which generally use a robot, can be implemented by utilizing this control method.

The calibration device is a device required when the force information is used to control a mechanical device, for example, a robot, in such a robot system. Moreover, when the robot carries out the work, a hand, a tool, and sensors used for the work are mounted to the tip of the robot arm 1 to carry out the work, and are referred to as tool parts. On this occasion, in order to carry out the work through the force control, it is necessary to precisely know a contact state between the tool part on the hand tip side and the work subject. In this case, the contact state is expressed as magnitudes of forces and moments and a direction vector.

A mechanical device, for example, a robot, can carry out work such as machining work, for example, deburring and polishing and assembly work involving a contact state by using the force information for the work, and, on this occasion, it is desired to carry out the work while the contact state is maintained in a target state for correct work by the mechanical device, for example, a robot. In this case, the target state is a contact state designed in advance for machining and work, and is adjusted by an operator together with a work speed and a required precision in accordance with a work object.

Incidentally, the force information is acquired as an electric signal from a sensor, for example, a force sensor or a load cell. Moreover, the sensor for acquiring the force information is mounted to a flange position on a hand tip side of the robot. The sensor outputs the electric signal through use of distortion of its structure, and hence a bias may be generated by distortion of the sensor structure when the structure is mounted to the robot, distortion of the structure generated by collision and the like, and zero point setting of an electric circuit of the sensor itself.

On this occasion, the zero point setting is setting for adjustment of adding an offset amount to an output value so as to cancel the generated bias component, and is generally carried out before the robot operation. Moreover, the bias is a steady offset amount output to the sensor, and it appears that an external force having a constant magnitude is acting independently of the attitude when only the sensor output is observed. In other words, even under a no-load state in which a force acting on the tool by the work subject is not generated, such measurement that a constant acting force seems to be generated occurs. Therefore, the bias component needs to be removed.

As described above, the impedance control and the force control are carried out in the control of a mechanical device, for example, a robot, using the force information. The impedance control is a control method of setting virtual rigidity and viscosity for a behavior of the tip of the tool part when an external force acts when a position command value is given for the control, and controlling a positional relationship between the work subject and the tool tip. Meanwhile, the force control is a control method of giving a force target value and carrying out control such that the force target value is followed.

On this occasion, each of the control methods can be applied to work, for example, assembly transportation or deburring, by appropriately setting a command value or an impedance parameter while a force or a positional relationship is set as a target state. Herein, the command value refers, for example, to a force target value of the force control, a position/attitude target value of the position control through the impedance control, and a hand tip speed command value while the position command is being carried out. Moreover, the impedance parameter represents, for example, each element value in a stiffness matrix, a damping matrix, and an inertial matrix in general impedance control.

When those controls are carried out, and a bias is generated in the force information, force information different in vector amount from an actual acting force acting from the outside is input to a control system. Therefore, the impedance control or the force control relating to the robot tool part is carried out based on the force different from the actual acting force, and the robot tool part does not thus reach a target position or state designed by a user, or the robot tool part cannot follow the target acting force specified by a controller. Thus, in general, an operation of decreasing the influence of the bias is often carried out.

For example, in a method as disclosed in paragraph 0031 of Patent Literature 1 of using force information acquired at a specific attitude as a bias amount for cancelation from an output value, a compensation amount for a gravity influence component changes in a case where the gravity direction and the direction of the tool tip can be changed through an attitude change, for example, a case of an articulated robot, and hence the calculated magnitude of the external force is inaccurate.

Moreover, in order to remove influence of an inertial force due to the gravity and the hand tip acceleration to obtain an accurate external force, an actual external force can accurately be calculated by accurately identifying the mass and the center-of-gravity position of the tool part, namely, a hand tip load with respect to the sensor, and simultaneously estimating bias amounts, thereby subtracting the bias amounts and the gravity action component of the hand tip load from the force information in advance.

Moreover, in each of the methods disclosed in Patent Literature 1 and Patent Literature 2, the force information in each of N attitudes (N=1, 2, . . . ) is acquired to estimate a tool mass, a tool center-of-gravity position, a gravity direction, and the like as parameters for the bias amount estimation and the like, but each of the methods assumes that the position information and the force information are acquired under a state in which the external force components are ideally removed from the acquired data.

Moreover, the external force component as the error in the acting force is assumed to be white noise, the influence of which can be decreased by filtering applied by, for example, a low-pass filter or a moving average filter, and error data generated depending on a specific direction is not considered.

However, as illustrated in FIG. 1, cables such as a force censor cable 5, a sensor cable 6 for a tactile sense sensor and a vision sensor, and an air cable 7 are actually provided as cables mounted to the tool tip depending on an object in the robot system and the mechanical system, and further power supply lines (not shown) are provided. Thus, external forces are generated by actions of the cables and the wires. Moreover, external force components other than sensor noise may be contained in the force information depending on methods of mounting those cables and wires.

As a result, when the methods disclosed in Patent Literature 1 and Patent Literature 2 are applied based on this information, it is difficult to determine how much influence is applied to respective pieces of data. Thus, for example, there is a problem in that a solution to which the least squares method or the like is applied is influenced by the error. This influence is not negligible for precise control.

Thus, in order to solve the above-mentioned problem, in the present invention, data obtained when, as an attitude at which the position information and the force information are acquired, an attitude is changed by rotation about an arbitrary axis of the sensor coordinate system is used to remove significant components of the acting external forces due to the cables and the wires, and components having certain tendencies are corrected to precisely estimate the biases. Further, force information after the bias estimation processing is used as input to precisely estimate the mass of the tool part, namely, the mass of the hand tip and the center-of-gravity position.

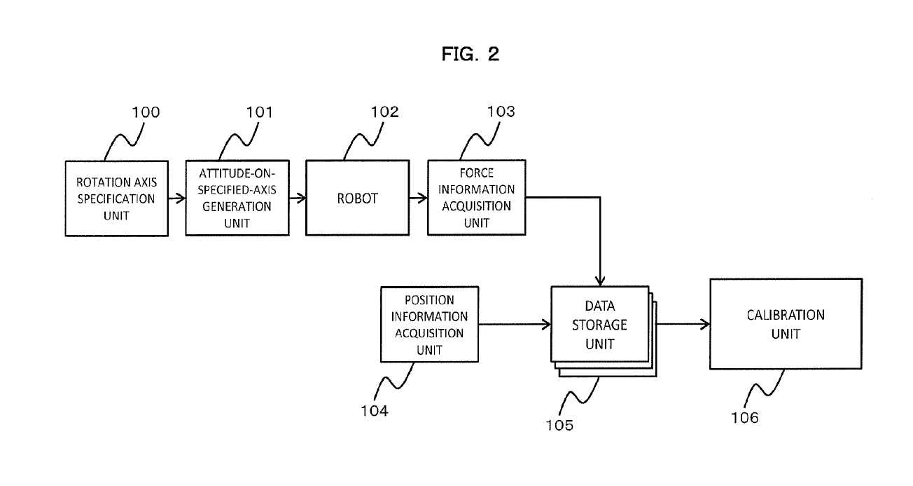

Now, referring to FIG. 2, a detailed description is now given of a calibration sequence of the calibration device according to the first embodiment of the present invention. FIG. 2 is a block configuration diagram for illustrating the calibration device according to the first embodiment of the present invention. The calibration device illustrated in FIG. 2 is configured to carry out calibration processing for information of the force sensor in order to extract only external force action components acting on the hand tip part of the robot and the tool tip relating to the work from the information of the force sensor.

When the robot takes a certain attitude Rₖ (k=1, 2, . . . , M), the force sensor information at the attitude Rₖ is denoted by F(k). On this occasion, the attitude is expressed as a rotation matrix Rₖ. Moreover, the rotation matrix is a 3×3 matrix expressing an attitude change of a coordinate system of current interest with respect to a certain reference coordinate system.

The force sensor information F(k) contains a bias F_bis(k), an acting force F_mas(k) corresponding to the hand tip load component, an external acting force F_ext(k), and a noise component F_nos(k) as an electric signal, and expressed as the following expression (1).

F(k)=F_bis(k)+F_mas(k)+F_ext(k)+F_nos(k) (1)

Moreover, the external force component F_ext(k) that needs to be obtained is derived by removing F_bis(k), F_mas(k), and F_nos(k) from the force sensor information F(k). The external force component F_ext(k) is expressed by the following expression (2) by transforming the expression (1).

F_ext(k)=F(k)−F_bis(k)−F_mas(k)−F_nos(k) (2)

On this occasion, a method of calculating the external force component F_ext(k) removes the noise component F_nos(k) through low-pass filtering or other filtering, calculates the bias values and the hand tip load influence based on load estimation for the tool part, and subtracts the bias values and the hand tip load influence. The bias components are constant forces when the tool is fixed, and specifically include axial forces and moments, and are independent of the attitude of the tool.

In other words, F_bis(k) does not depend on the attitude k, and is the same value, F_bis(k)=[F_bis_x, F_bis_y, F_bis_z, M_bis_x, M_bis_y, M_bis_z], for all attitudes k. Moreover, F_mas(k) can be calculated by obtaining a relationship among the mass, the sensor coordinate system and the center-of-gravity position.

In general, a plurality of attitudes Rₖ are taken while external forces are not applied, and the calibration processing is carried out based on the position information and the force information on those occasions. In the present invention, in a case where data treated during the calibration includes the force information in which F_ext(k) is not 0, precise calibration processing is carried out by applying constraint conditions to the acquisition attitudes, and the acting force F_ext(k) caused by the external force components is calculated based on this calibration processing. A description is now given of this method.

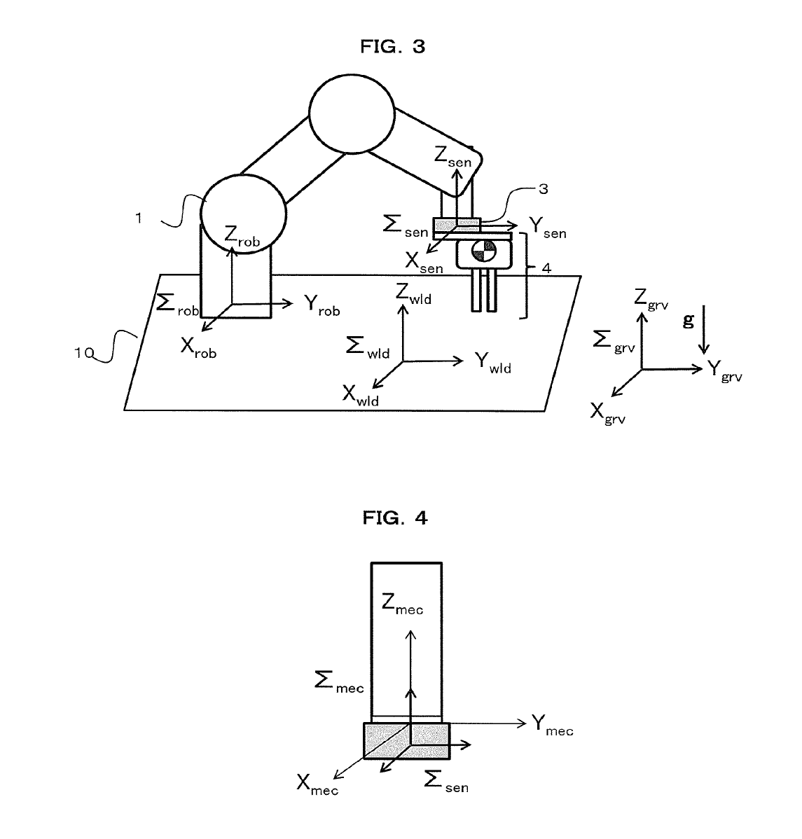

FIG. 3 is an explanatory diagram for illustrating an example of a positional relationship among a robot coordinate system, a world coordinate system, a gravity coordinate system, and a sensor coordinate system of the robot system according to the first embodiment of the present invention. As illustrated in FIG. 3, the robot coordinate system defined as a reference coordinate system of a robot main body fixed in the system is denoted by Σrob, the world coordinate system defined as a coordinate system common to devices in the same system is denoted by Σwld, and the gravity coordinate system having a −Z direction as a gravity acceleration direction is denoted by Σgrv.

In general, leveling is often precisely carried out through use of a level so that a normal direction of a top surface of a stand on which the robot is installed, namely, a Z direction of the robot coordinate system Σrob, and the gravity direction, which is a Z axis direction of the gravity coordinate system Σgrv, are orthogonal to each other. Thus, in an automated system, the Z axes of the robot coordinate system Σrob and the gravity coordinate system Σgrv thus approximately match each other, and influence of error is assumed to be small.

Moreover, as a definition of the gravity coordinate system, an X axis direction and a Y axis direction of Σgrv are assumed to match those of the robot coordinate system Σrob for the sake of simplicity. Moreover, when a robot system is built based on design drawings, a position/attitude relationship is assumed to be known at a precision described in the drawing, and hence a homogeneous transformation matrix ^{wld}T_{rob} may also be assumed to be known as a relative relationship between the world coordinate system Σwld and the robot coordinate system Σrob. In other words, a description is given while initial values of the relative relationships among Σwld, Σrob, and Σgrv are assumed to be roughly estimated.

Herein, a part to which a sensor and a tool can be mounted at an end of the robot arm is referred to as a robot mechanical flange. A coordinate system of the robot mechanical flange can be calculated based on a hand tip position command value with respect to the robot coordinate system.

A description is now given of a method of defining a sensor coordinate system Σsen when a sensor is mounted to the robot mechanical flange. A case in which output information corresponds to three axes or six axes is assumed in the present invention, but X axis, Y axis, and Z axis directions of the sensor coordinate system Σsen are defined with respect to a housing of the sensor in advance, and are thus assumed to be followed.

FIG. 4 is an explanatory diagram for illustrating an example of a relationship between a mechanical flange coordinate system and the sensor coordinate system of the robot system according to the first embodiment of the present invention. As illustrated in FIG. 4, when the mechanical flange coordinate system with respect to the robot coordinate system is denoted by Σmec, a homogeneous transformation matrix can be obtained by comparing the coordinate system of the mechanical flange and the sensor coordinate system Σsen defined in this example with each other. Errors are contained in a strict sense, but initial values can be treated as being known.

On this occasion, the homogeneous transformation matrix is a 4×4 matrix constructed by a rotation matrix R (3×3) and a position vector P representing a positional relationship defined in a reference coordinate system. For example, when a homogeneous transformation matrix ^{wld}T_{rob} is expressed while the coordinate system serving as a reference is set to the world coordinate system Σwld and the coordinate system of interest is set to the robot coordinate system Σrob, the rotation matrix R, the position vector P, and the homogeneous transformation matrix ^{wld}T_{rob} are expressed as the following expressions (3) to (5).

$$\begin{matrix}{}_{}^{wld}{R}{}_{rob}^{} = ( \begin{matrix}{R}_{11} & {R}_{12} & {R}_{13} \\ {R}_{21} & {R}_{22} & {R}_{23} \\ {R}_{31} & {R}_{32} & {R}_{33}\end{matrix} ) & ( 3 ) \\ {}_{}^{wld}{P}{}_{rob}^{} = ( \begin{matrix}{}_{}^{wld}{P}{}_{rob}^{} \\ {}_{}^{wld}{P}{}_{rob}^{} \\ {}_{}^{wld}{P}{}_{rob}^{}\end{matrix} ) & ( 4 ) \\ {}_{}^{wld}{T}{}_{rob}^{} = ( \begin{matrix}{R}_{11} & {R}_{12} & {R}_{13} & {}_{}^{wld}{P}{}_{rob , x}^{} \\ {R}_{21} & {R}_{22} & {R}_{23} & {}_{}^{wld}{P}{}_{rob , y}^{} \\ {R}_{31} & {R}_{32} & {R}_{33} & {}_{}^{wld}{P}{}_{rob , z}^{} \\ 0 & 0 & 0 & 1\end{matrix} ) & ( 5 )\end{matrix}$$

In a case where the above-mentioned positional relationships are established, when the bias can further precisely be estimated and the mass and the center-of-gravity position of the tool part are known, the external force component F_ext(k) can be calculated. A reason why the external force component F_ext(k) cannot be calculated correctly is that there exist a case in which the positional relationship among the respective coordinate systems is not accurate and displacements exist in the gravity direction and the gravity acceleration, a case in which a bias component is inaccurate, and a case in which the mass and the center-of-gravity position of the tool part are inaccurate.

In contrast, the present invention has a feature in that parameters for minimizing the errors through optimization calculation are not calculated, and a unique operation is carried out to remove data that may be error factors and carry out individual estimation processing, thereby increasing the estimation accuracy of the bias, the object mass, and the center-of-gravity position.

Thus, first, the position information and the force information required for the calibration processing for the robot are acquired. Position information on the tool part is acquired as the position information, and the position information refers to [X, Y, Z], which are translational three degrees of freedom along the X axis, the Y axis, and the Z axis represented in an orthogonal coordinate system, and [A, B, C], which are rotational three degrees of freedom about the X axis, the Y axis, and the Z axis in the Euler representation. On this occasion, in order to acquire the position information and the force information for the calibration, an arbitrary rotation axis Vec_rot passing through the origin of the sensor coordinate system is specified by a rotation axis specification unit 100 of FIG. 2.

On this occasion, the position information and the force information are acquired in an attitude rotated about the rotation axis Vec_rot specified by the rotation axis specification unit 100 in the calibration using the definition of the sensor coordinate system as a reference. Therefore, an attitude-on-specified-axis generation unit 101 of FIG. 2 is configured to determine an attitude for acquiring the position information and the force information based on the rotation axis Vec_rot, and output the attitude as an attitude command value.

Errors decrease as a rotation amount about the rotation axis Vec_rot from position/attitude serving as a reference increases, and hence respective attitudes may be determined for acquisition at an interval of 45 degrees in a forward rotation direction about the rotation axis Vec_rot. Meanwhile, as described later, in the present invention, the estimation processing can be carried out even when the rotation amount about the rotation axis Vec_rot is small, and hence the information can be acquired even when a large restriction is imposed on the attitude change due to such a reason as interference with peripheral objects.

Moreover, the X axis, the Y axis, and the Z axis of the sensor coordinate system, which are main axes of the sensor coordinate system, may be specified as the rotation axis Vec_rot. An approximate curve generation unit, which is described later, needs to define a main axis orthogonal to a surface orthogonal to the specified rotation axis, and hence, when the main axis of the sensor coordinate system is specified in advance, translation processing is not necessary. Meanwhile, an axis other than the main axes may be specified as the rotation axis, and hence a user may determine the rotation axis in consideration of interference with a peripheral environment, or a manufacturer may determine the rotation axis Vec_rot and the rotation angle amount θ in advance.

Data used for the calibration is acquired by carrying out the attitude change based on the attitude command value about the rotation axis Vec_rot specified in this way. For example, a load cell or a force sensor is used as a force information acquisition unit 103 mounted to the robot 102 to acquire the force information from the current robot state.

Moreover, a position information acquisition unit 104 is configured to use information from, for example, encoders mounted to the respective axes of the robot to calculate the hand tip position of the robot, and further acquire position information for acquiring the position/attitude in the sensor coordinate system. The position information acquisition unit 104 may be configured to measure a marker, which is mounted to the robot tool part, with the vision sensor, to thereby measure or estimate the robot attitude from the outside of the robot.

On this occasion, when the external sensor is used, influence of errors such as backlashes and deflections, which are mechanical errors unique to the robot, does not need to be considered. When the external sensor is mounted, regarding a sensor mounting position with respect a reference coordinate system, which is the robot coordinate system Σrob or the world coordinate system Σwld, it is necessary to use a jig for accurate positioning or to use an external sensor to refer to a reference marker or the like, to thereby estimate the installation position.

It is necessary to acquire the position information and the force information for the calibration of rotating the robot tool tip in this way, and acquire at least three points for the one rotation axis Vec_rot. This is because the calibration device applies approximation of using a circle. It is basically desired to consider the influence of the errors at at least four points.

In this way, the position information and the force information are acquired and stored in a data storage unit 105 while the attitude is changed about the rotation axis Vec_rot. Then, the stored data is used to carry out the calibration processing in a calibration unit 106.

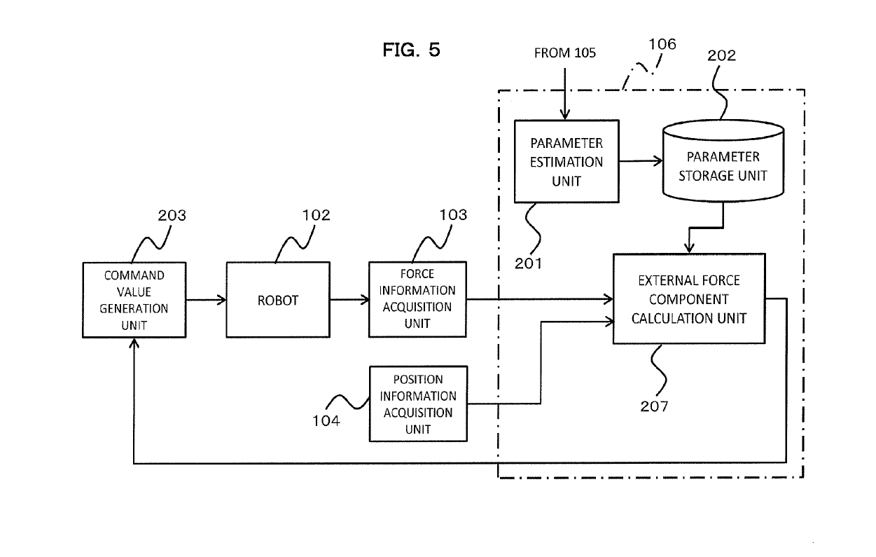

FIG. 5 is a block configuration diagram for illustrating a calibration unit of the calibration device according to the first embodiment of the present invention, and the robot system using the calibration device. When the calibration device is used, parameter estimation processing is first carried out in a parameter estimation unit 201 configured to obtain parameters. Then, processing of using the estimated parameters to subtract the bias values and the gravity influence component from the force information is carried out when the robot is actually used to carry out work (in a normal operation). A description is now given of this point.

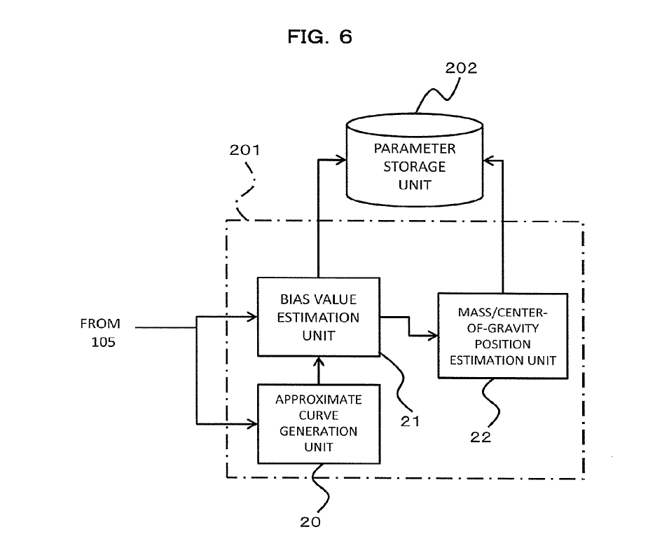

In FIG. 5, in this calibration device, the parameter estimation unit 201 obtains the mass of the hand tip load including the tool part, the center-of-gravity position of the hand tip load including the tool part, and the biases, which are the parameters. This parameter estimation unit is described later with reference to FIG. 6.

Then, the robot 102 operates in accordance with an attitude command value generated by a command value generation unit 203 in the normal operation, and the force information is acquired by the force information acquisition unit 103 in accordance with the current robot state. On this occasion, an external force component calculation unit 207 calculates the acting component F_mas(k) of the force due to the hand tip load mass at the current position/attitude Rₖ of the robot acquired by the position information acquisition unit 104 based on the parameters stored in a parameter storage unit 202.

Moreover, as expressed by the expression (2), the external force component calculation unit 207 subtracts the acting component F_mas(k) of the force due to the hand tip load mass and the acting component F_bis due to the bias from the sensor data F(k), to thereby obtain the external force component F_ext(k) due to the contact. Moreover, the external force component calculation unit 207 feeds back the external force component as an acting external force calculation value to the command value generation unit 203, to thereby carry out the calibration processing.

As described above, the calibration unit 106 includes the parameter estimation unit 201 configured to carry out the parameter estimation processing of obtaining the parameters for the robot 102 based on the position information and the force information stored in the data storage unit 105, the parameter storage unit 202 configured to store the estimation result obtained by the parameter estimation unit 201, and the external force component calculation unit 207 configured to use the stored parameters to remove the acting component of the forces due to the biases and the acting component of the forces due to the hand tip load mass, to thereby obtain the external force component due to the contact. In the present invention, the calibration unit 106 is applied to the robot system constructed by the command value generation unit 203, the robot 102, the force information acquisition unit 103, and the position information acquisition unit 104.

A detailed description is now given of the parameter estimation unit 201, which is a feature of the present invention. FIG. 6 is a block configuration diagram for illustrating in detail the parameter estimation unit included in the calibration unit of the calibration device according to the first embodiment of the present invention.

As illustrated in FIG. 6, a plurality of pieces of data are acquired at the attitudes rotated about the rotation axis Vec_rot specified by the rotation axis specification unit 100, the acquired data is stored in the data storage unit 105, and the bias values and a preliminary mass are first obtained in the parameter estimation unit 201. Moreover, the parameter estimation unit 201 estimates the mass and the center-of-gravity position based on the obtained bias values and preliminary mass. The information on the estimated mass and center-of-gravity position is output to the parameter storage unit 202.

A description is now given of a specific method of obtaining the bias values by a bias value estimation unit 21 and an approximate curve generation unit 20 included in the parameter estimation unit 201. First, a case of rotation about, as the rotation axis Vec_rot, the main axis of the sensor coordinate system as one of arbitrary axes of the sensor coordinate system in a plane perpendicular to the gravity direction is considered. Herein, a direction in which the sensor −Z axis direction matches the gravity direction is set as a reference attitude Rₖ₀. Moreover, the Y axis of the main axes of the sensor coordinate system is selected as the rotation axis Vec_rot.

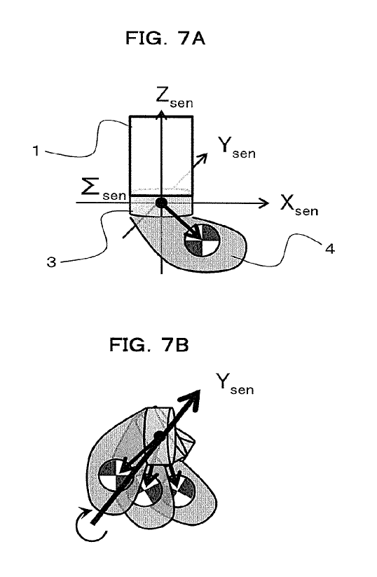

Referring to FIG. 7 to FIG. 9, a description is now given of a calculation method for bias values F_bis_x, Fbis_y, and F_bis_z of the axial forces. FIG. 7A and FIG. 7B are explanatory diagrams for illustrating an example of an operation in accordance with the attitude command value generated by the attitude-on-specified-axis generation unit in the calibration device according to the first embodiment of the present invention. As illustrated in FIG. 7, at least three attitudes rotated about the Y axis from the reference attitude Rₖ₀ are acquired. Pieces of axial force data Fx and Fz acquired on this occasion are illustrated so that Fz is assigned to the vertical axis and Fx is assigned to the horizontal axis.

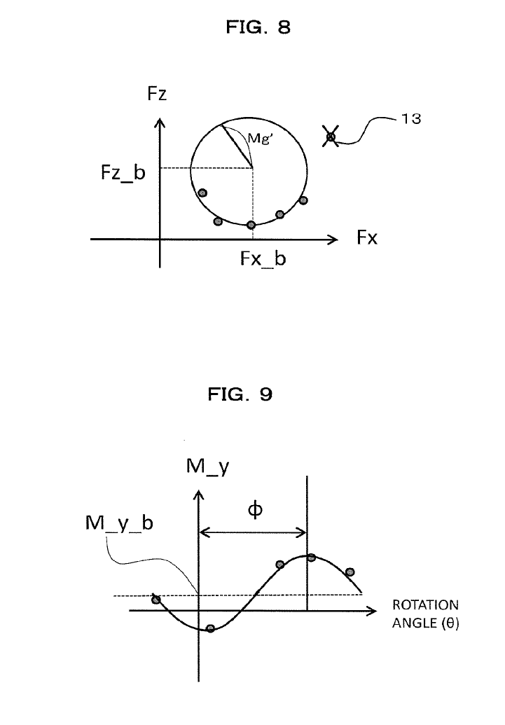

When the rotation axis is selected in a plane perpendicular to the gravity direction, and vector changes in the acting forces in the rotation motion are focused on, as illustrated in FIG. 8, such a characteristic appears that plots of the force information assigned to axes orthogonal to the rotation axis, which are the X axis and the Z axis in this case, form a circle trajectory. This characteristic is used to generate an approximate curve that forms a circle when the data acquired at each of the positions/attitudes is plotted for the acquired force information.

In the approximate curve generation unit 20, an axial force in the X axis direction obtained when the gravity direction is aligned to the −Z axis of the sensor coordinate system and the rotation is carried out about the Y axis is set to Fx, and an axial force in the Z axis direction is set to Fz. Then, circle approximation for the respective points (Fx, Fz) is obtained while Fx is assigned to the horizontal axis and Fz is assigned to the vertical axis. When an offset amount from an origin, which is a center of a circle, is represented as Fx_b in a horizontal axis direction for plotting the X axial force, and as Fz_b in a vertical axis direction for plotting the Z axial force, the circle approximation can be defined as the following expression (6) as a formula of a circle having Fx_b, Fz_b, and a radius R of the circle as variables.

(Fx−Fx_b)∧2+(Fz−Fz_b)∧2=R∧2 (6)

On this occasion, in order to obtain a least squares approximation solution of those polynomials, a function f(Fx_b, Fz_b, R) having Fx_b, Fz_b, and R as the variables is defined as the following expression (7), and least squares approximation of obtaining a solution that makes a result obtained by squaring and partially differentiating 0 can be applied to the function.

f(Fx_b,Fz_b,R)=(Fx−Fx_b)∧2+(Fz−Fz_b)∧2−R∧2 (7)

Fx_b and Fz_b obtained by this expression are the bias value F_bis_x of the X axial force and F_bis_z of the Z axial force. R obtained by this expression is an external force Mg′ corresponding to the mass. The mass obtained from this external force Mg′ is set as a preliminary mass M_tmp. Moreover, F_bis_y is also obtained by changing the rotation main axis to the X axis and carrying out the same processing. The bias values relating to the axial forces can be calculated in this way.

Moreover, the approximate curve generation unit 20 obtains the bias values relating to the moments as follows. First, regarding the moments, when a rotation motion is carried out, and Y axis is selected as the rotation axis Vec_rot, as illustrated in FIG. 9, the attitude change Rₖ about the rotation axis Vec_rot has such a characteristic as to be approximated as a curve obtained by multiplying a cosine curve by a phase difference and an offset.

In other words, a numerical model of the moment is defined as a phase difference φ when the bias component of the moment about the Y axis is denoted by M_y_b, a rotation angle about the Y axis from the reference attitude Rₖ₀ is denoted by θ, θ is assigned to the horizontal axis, and the moment is assigned to the vertical axis. Moreover, the amplitude of the cosine curve is denoted by Am. When moment data acquired on this occasion is denoted by M_y, the following expression (8) holds.

M_y=M_y_b+Am*COS(θ+φ) (8)

Periodicity for the rotation angle θ is characterized by such a frequency that 360 degrees correspond to just one cycle. A function f(M_y_b, Am, φ) is defined as the following expression (9) for this model, and approximate solutions relating to M_y_b, Am, and φ can be obtained by iterative calculation through the Newton-Raphson method.

f(M_y_b,Am,φ)=M_y−M_y_b−Am*COS(θ+φ) (9)

M_y_b obtained by this expression is the bias value M_bis_y of the moment about the Y axis to be obtained. When the convergence of the solution is slow, and an approximate solution is not obtained, angles may be selected by dividing 360 degrees by a divisor of 360, for example, 0 degrees and 180 degrees as θ in case of 2, and 0 degrees, 90 degrees, 180 degrees, and 270 degrees as θ in case of 4, and an average of My at respective angles may be obtained.

Moreover, similarly, M_bis_x can be obtained by selecting the X axis as the rotation axis Vec_rot. Moreover, for M_bis_z, as carried out for the Y axis and the X axis, an attitude Rₖ₁ which aligns the Z axis with the plane orthogonal to the gravity direction is set as the reference position, the Z axis is selected as the rotation vector Vec_rot, and the same processing as that carried out when the M_bis_y is obtained can be carried out.

As another method, the rotation axis Vec_rot is selected as the Z axis simply from the attitude of Rₖ₀, angles may be selected by dividing 360 degrees by a divisor of 360, for example, 0 degrees and 180 degrees as θ in case of 2, and 0 degrees, 90 degrees, 180 degrees, and 270 degrees as θ in case of 4, and an average of M_z at respective angles may be obtained.

With the method described above, the approximate curve generation unit 20 carries out the preliminary bias value estimation from the expressions of the approximated curves, to thereby obtain the bias values F_bis and the preliminary mass M_tmp.

On this occasion, when data obtained in a case where a cable is caught is mixed, there exists a point, for example, error data 13 of FIG. 8. A feature of the present invention is to remove this point during the calibration processing from the approximate curve, which is the result of the approximate curve generation unit 20, the force information, and the position information.

Specifically, when several points of the error data illustrated in FIG. 8 exist, and data is acquired at a total of N attitudes Rₖ, N pieces of data are divided into groups each containing N-M pieces of data, and the error data can be extracted by comparing the maximum error in each group. M and N are positive integers satisfying M<N.

Moreover, the calculation of the hand tip load mass and the center-of-gravity position of the tool part is carried out by a mass/center-of-gravity position estimation unit 22 of FIG. 6. On this occasion, the axis setting for the force control is carried out so that, in the coordinate axis setting of the X axis, the Y axis, and the Z axis in the calibrated state, the sensor coordinate system Σsen is placed at the sensor center position, and a center-of-gravity coordinate system Σ_{L} is defined in the same attitude as the mechanical flange coordinate system Σmec at the center-of-gravity position of the hand tip load.

On this occasion, a positional relationship (xq, yq, zq, Aq, Bq, Cq) between the sensor coordinate system and the center-of-gravity coordinate system of the hand tip load and the mass m are defined as an unknown variable q. In other words, q is defined as (xq, yq, zq, Aq, Bq, Cq, m).

On this occasion, when an error between the model and the sensor output is defined as a difference between a force F_{mdl} estimated from the model and the above-mentioned data ^{s}Fᵢ actually acquired by the sensor, the error between the model and the sensor output is expressed by the following expression (10). As an initial value, m=M_tmp.

$$\begin{matrix}f ( q ) = {F}_{mdl , k} - {}_{}^{s}{F}{}_{k}^{} \\ = {( \begin{matrix}{F}_{mdl , 1} - {}_{}^{s}{F}{}_{1}^{} \\ {F}_{mdl , 2} - {}_{}^{s}{F}{}_{2}^{} \\ ⋮ \\ {F}_{mdl , n} - {}_{}^{s}{F}{}_{n}^{}\end{matrix} )}^{T}\end{matrix} \qquad ( 10 )$$

In other words, finding q having the minimum error is an original object, and hence the problem can be reduced to a problem of obtaining qᵢ so that each f(qᵢ) approaches 0 by iterative calculation. Symbol i denotes the iteration.

Moreover, according to the Newton-Raphson method, when the variable qᵢ for the asymptotical approach to 0 is obtained, a renewal rule expressed as the following expression (11) holds true.

$${q}_{i + 1} = {q}_{i} - \frac{f ( {q}_{i } )}{{f}^{′} ( {q}_{i} )} \qquad ( 11 )$$

On this occasion, the expression is changed to a form of a difference in calculation carried out each time for approximate approach through the iterative calculation, the following expression (12) is obtained.

qᵢ₊₁=qᵢ+dqᵢ (12)

When the expression is specifically expanded, an obtained form is calculation of the following expression (13).

$${dq}_{i} = {( \begin{matrix}\frac{\partial ( {F}_{mdl , 1} - {}_{}^{s}{F}{}_{1}^{} )}{\partial {x}_{s}} & \frac{\partial ( {F}_{mdl , 1} - {}_{}^{s}{F}{}_{1}^{} )}{\partial {y}_{s}} & … & \frac{\partial ( {F}_{mdl , 1} - {}_{}^{s}{F}{}_{1}^{} )}{\partial {b}_{w}} \\ \frac{\partial ( {F}_{mdl , 2} - {}_{}^{s}{F}{}_{2}^{} )}{\partial {x}_{s}} & \frac{\partial ( {F}_{mdl , 2} - {}_{}^{s}{F}{}_{2}^{} )}{\partial {y}_{s}} & … & \frac{\partial ( {F}_{mdl , 2} - {}_{}^{s}{F}{}_{2}^{} )}{\partial {b}_{w}} \\ & ⋮ & & \\ \frac{\partial ( {F}_{mdl , n} - {}_{}^{s}{F}{}_{n}^{} )}{\partial {x}_{s}} & \frac{\partial ( {F}_{mdl , n} - {}_{}^{s}{F}{}_{n}^{} )}{\partial {y}_{s}} & … & \frac{\partial ( {F}_{mdl , n} - {}_{}^{s}{F}{}_{n}^{} )}{\partial {b}_{w}}\end{matrix} )}^{†} ( \begin{matrix}{F}_{mdl , 1} - {}_{}^{s}{F}{}_{1}^{} \\ {F}_{mdl , 2} - {}_{}^{s}{F}{}_{2}^{} \\ ⋮ \\ {F}_{mdl , n} - {}_{}^{s}{F}{}_{n}^{}\end{matrix} ) \qquad ( 13 )$$

The expression (13) is an expression obtained by arranging the expression (11) and the expression (12) in terms of dq. A description is now given of the expression (13), and variables relating to partial differentiations on the right side are generally defined by all the variables relating to q. On this occasion, a estimation method for the mass/center-of-gravity position of the hand tip load is expressed by a general form that considers the gravity direction, and the variables to be estimated are the center-of-gravity position=(Xs, Ys, Zs, As, Bs, Cs), the mass m, and the gradient of the gravity vector with respect to the world coordinate system Σwld expressed in a form of rotation amounts about the X axis and the Y axis using Aw and Bw as variables.

When the gradient of the gravity direction is known, and is removed as in the first embodiment of the present invention, the variables to be estimated may be set to the center-of-gravity position=(Xq, Yq, Zq, Aq, Bq, Cq) and the mass m other than Aw and Bw. In terms of the above-mentioned variable q, the variables to be partially differentiated are Xq, Yq, Zq, Aq, Bq, Cq, and m.

On this occasion, the force F_{mdl} that is estimated from the model can be defined as follows. The center-of-gravity coordinate system Σ_{L} is defined in the same axial directions as those of the mechanical flange coordinate system Σmec, an external force vector caused by the mass, which is a three dimensional vector of the axial forces with respect to the center-of-gravity coordinate system Σ_{L}, is expressed as ^{L}f, a moment vector caused by the mass with respect to the same center-of-gravity coordinate system Σ_{L} is expressed as ^{L}m, and a gravity acceleration vector with respect to the center-of-gravity coordinate system is expressed as ^{L}g. Moreover, an attitude matrix (3×3) to the center-of-gravity coordinate system Σ_{L} with respect to the world coordinate system Σwld is expressed as ^{w}R_{L}. The following expression (14) expresses the definition of F_{mdl}, and the following expressions (15) to (21) express definitions of the elements of the expression (14).

F_{mdl}=(^{S}f_{x,mdl}^{S}f_{y,mdl}^{S}f_{z,mdl}^{S}m_{x,mdl}^{S}m_{y,mdl}^{S}m_{z,mdl})^{T} (14)

^{s}F_{x,mdl}=n·^{L}f=n·m^{L}g (15)

^{s}f_{y,mdl}=o·^{L}f=o·m^{L}g (16)

^{s}f_{z,mdl}=a·^{L}f=a·m^{L}g (17)

^{s}m_{x,mdl}=n·(^{L}f×^{L}p_{S}+^{L}m) (18)

^{s}m_{y,mdl}=o·(^{L}f×^{L}p_{S}+^{L}m) (19)

^{s}m_{z,mdl}=a·(^{L}f×^{L}p_{S}+^{L}m) (20)

$${}^{L} g = {}_{}^{W}{R}{}_{L}^{- 1} ( \begin{matrix}0 \\ 0 \\ - g\end{matrix} ) \qquad ( 21 )$$

A positional relationship between the sensor and the load center of gravity, namely, a homogeneous transformation matrix ^{L}T_{S} to the sensor coordinate system with respect to the center-of-gravity position of the tool part, is defined as the following expression (22).

$${}_{}^{L}{T}{}_{S}^{} = ( \begin{matrix}n & o & a & {}_{}^{L}{p}{}_{S}^{} \\ 0 & 0 & 0 & 1\end{matrix} ) \qquad ( 22 )$$

Moreover, n, o, and a in this expression are defined by the following expression (23) through use of Eulerian angles (A, B, C) in a case of an attitude change from the center-of-gravity coordinate system Σ_{L} to the sensor coordinate system Σsen.

$$\{ \begin{matrix}n = {( cos C cos B , sin C sin B , - sin B )}^{T} \\ o = {( \begin{matrix}- cos C sin B sin A - sin C sin A , \\ sin C sin B sin A - cos C cos A , - cos B sin A\end{matrix} )}^{T} \\ a = {( \begin{matrix}cos C sin B cos A + sin C sin A , \\ sin C sin B cos A - cos C sin A , - cos B cos A\end{matrix} )}^{T}\end{matrix} \qquad ( 23 )$$

When update is carried out through use of the expression (12) and the expression (13) based on the above-mentioned definition, the expression (10) asymptotically approaches 0. As a result, the mass m and (xq, yq, zq, Aq, Bq, Cq) as the relative relationship between the sensor coordinate system and the center-of-gravity position of the tool part can be obtained.

The relative relationship between the robot coordinate system rob and the sensor coordinate system Σsen is assumed be known through the calibration at the time of the sensor installation, and the gravity direction is assumed to be known with respect to the robot coordinate system rob through use of, for example, a level as described above. As a result, an influence component of the gravity or the inertial forces of the hand tip load in the sensor coordinate system can be calculated from a relationship between the gravity direction with respect to the sensor coordinate system Σsen and the mass m. The information on the gravity direction is not limited to that acquired by using a level.

As described above, with the above-mentioned calibration device, the error data that was not removed can be removed. Moreover, the mass and the center-of-gravity position of the tool part, which are calculated based on the accurate bias values obtained as a result, can be obtained more precisely. Therefore, an increase in the precision of the force information calibration using the force information containing the error data, which cannot be obtained up to now, can be implemented, and hence such an effect that force control performance significantly increases is expected.

As described above, according the first embodiment, there is provided the calibration device, which is configured to extract, in the mechanical device configured to carry out the force control of the tool part, which is mounted to the tip of the mechanical device and configured to act on the work subject, only the external force generated in the tool part by the contact with the work subject, the calibration device including: the position information acquisition unit configured to acquire the position information on the tool part; the force information acquisition unit configured to acquire the force information on the force acting on the tool part; the rotation axis specification unit configured to specify the arbitrary rotation axis passing through the origin of the sensor coordinate system; the attitude generation unit configured to generate the attitude command value for rotating the tool part about the arbitrary rotation axis; and the calibration unit configured to carry out the calibration processing of subtracting the bias value and the gravity action component of the hand tip load from the force information, to thereby extract only the external force generated by the contact with the work subject, in which the calibration unit includes: the approximate curve generation unit configured to generate the approximate curve based on the position information and the force information that are obtained when the tool part is rotated in accordance with the attitude command value; the bias value estimation unit configured to estimate the bias value of the force information based on the approximate curve, the position information, and the force information; the mass/center-of-gravity position estimation unit configured to remove the bias value from the force information, and to calculate the mass and the center-of-gravity position vector of the hand tip load through use of the force information from which the bias value is removed; and the external force component calculation unit configured to subtract the bias value and the gravity action component of the hand tip load from the force information through use of the estimated bias value, and the mass and the center-of-gravity position vector of the hand tip load.

Therefore, it is possible to remove the bias components in consideration of the influence of external forces and precisely calculate the hand tip load mass and the center-of-gravity position vector, thereby carrying out calibration precisely.

Moreover, the bias values can be estimated independently and precisely, and an overall calibration precision consequently increases. Thus, and precise force control, which has not been available up to now, can be carried out.

### Second Embodiment

In the calibration device according to the first embodiment, in order to extract error data caused by the cables, wires, and the like, the data is divided into some groups, and a group that causes a great deviation in the result is identified, to thereby find the error data. However, only with this configuration, the error data may not be removed in, for example, the following case.

Case Example 1: a case in which a large amount of error data is contained. In this case, it is difficult to extract only the error data.

Case Example 2: a case in which the rotation axis of the sensor coordinate system and the rotation axis given by the robot are displaced from each other, and an approximate curve cannot be fit in a circle shape.

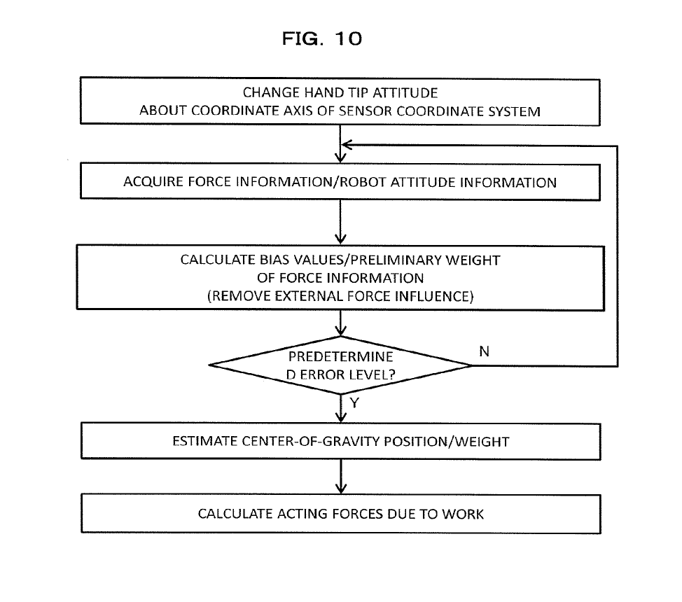

Thus, in order to solve those problems, a second embodiment of the present invention has the following feature. Specifically, as illustrated in FIG. 10, the bias value estimation unit 21 determines whether or not an increase amount of the force information generated by the action of the external forces due to the cables and wires mounted to the tool part has reached a predetermined error level, that is, exceeds a set value. When the increase amount has reached the error level, the bias value estimation unit 21 passes the processing to the mass/center-of-gravity position estimation unit 22, and otherwise additionally acquires a new attitude.

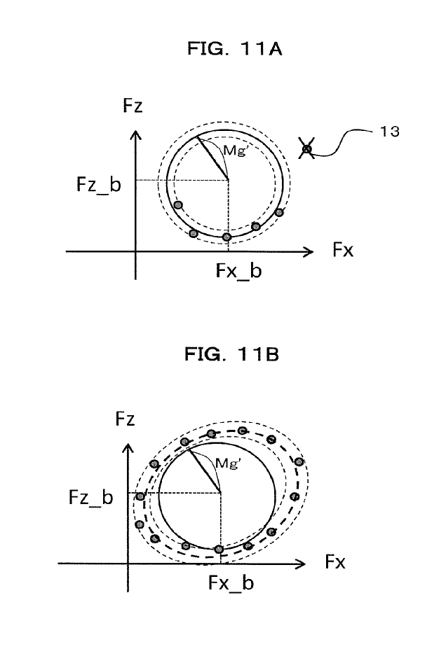

As illustrated in FIG. 11A, in a case of a circle, circles changed in the radius by +X % from the circle for fitting are newly defined, and are used as thresholds of the predetermined error level. The value of X is individually defined in accordance with magnitudes of variations of the external forces due to the cables and the wires, and the force received due to the noise.

This is because when the variation in the force due to the noise is great, the influence of noise can be decreased by filtering, but when the value of X is too small, the entire data may be considered as the error data.

With the calibration device according to the second embodiment of the present invention, data deviating from the predetermined error level can gradually be removed, and hence the data can be caused to approach data not containing the error data.

Moreover, as illustrated in FIG. 11B, in a case corresponding to Case Example 2, ellipsoid fitting is necessary. This case may be treated by replacing the expression of the circle expressed by the expression (6) with an expression of an ellipsoid to define the approximation. In this case, evaluation is carried out still as the ellipsoid, and hence the approximation can be defined in the form of +X % of each of the minor axis and the major axis.

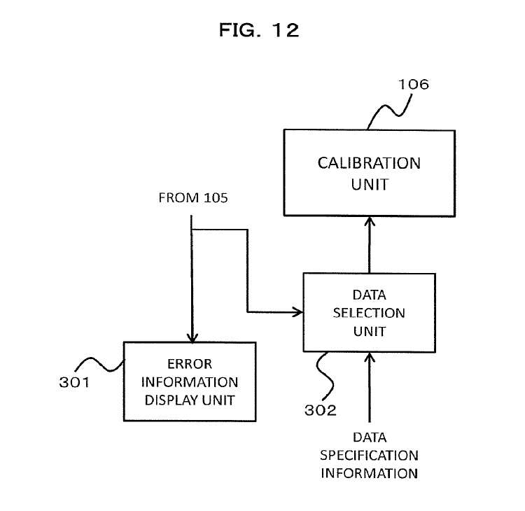

Further, as another method, as illustrated in FIG. 12, the calibration processing may be carried out by removing the error data through processing of causing a user to select the error data via an error information display unit 301 and a data selection unit 302. The error information display unit 301 is configured to display the position information and the force information stored in the data storage unit 105 as graphs in the form illustrated in FIGS. 11A and 11B. The data selection unit 302 allows selection of data through use of an input device such as a mouse, a keyboard, or a touch panel.

As described above, according to the second embodiment, even when a plurality of pieces of error data are contained, data can be appropriately selected, and precise calibration can thus be implemented, resulting in precise force control, which has not been available up to now.

### Third Embodiment

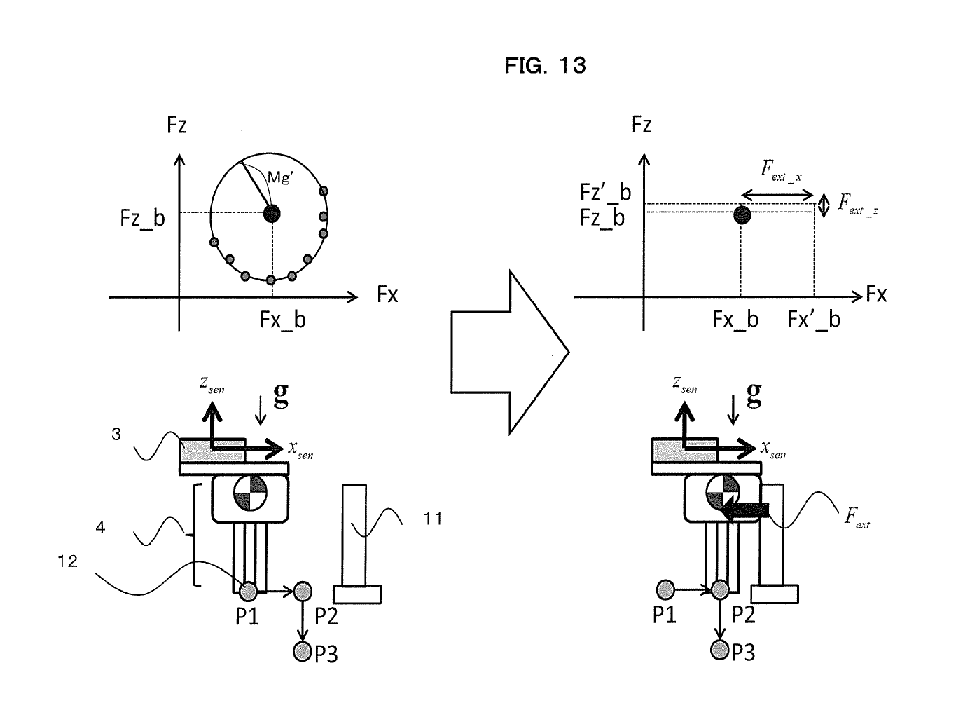

The calibration device according to the first embodiment or the second embodiment can carry out the calibration inconsideration of the influence of the mass caused by the tool part. However, for example, as illustrated in FIG. 13, when work starts at a position P2 in a robot that follows teaching points 12, the force control may not need to be applied to the external force F_ext acting on the time point corresponding to P2. In other words, the work may need to be continued to a position P3 while a state of contact with a peripheral object 11 of the robot generated at the time point corresponding to the position P2 is maintained.

In this case, simple application of the calibration to the tool part is insufficient, and control of maintaining the contact state is difficult. Meanwhile, a system for carrying out a simple zero point adjustment cannot handle the attitude change in the tool part. Therefore, for example, when the attitude of the tool part is changed in a direction not constrained by the peripheral object 11 of the robot, for example, a direction of rotation about Xₛₑₙ, the axial direction of the gravity changes with respect to the sensor coordinate system. Thus, the influence of the attitude change of the tool part cannot be considered, and it is erroneously determined that an external force acts.

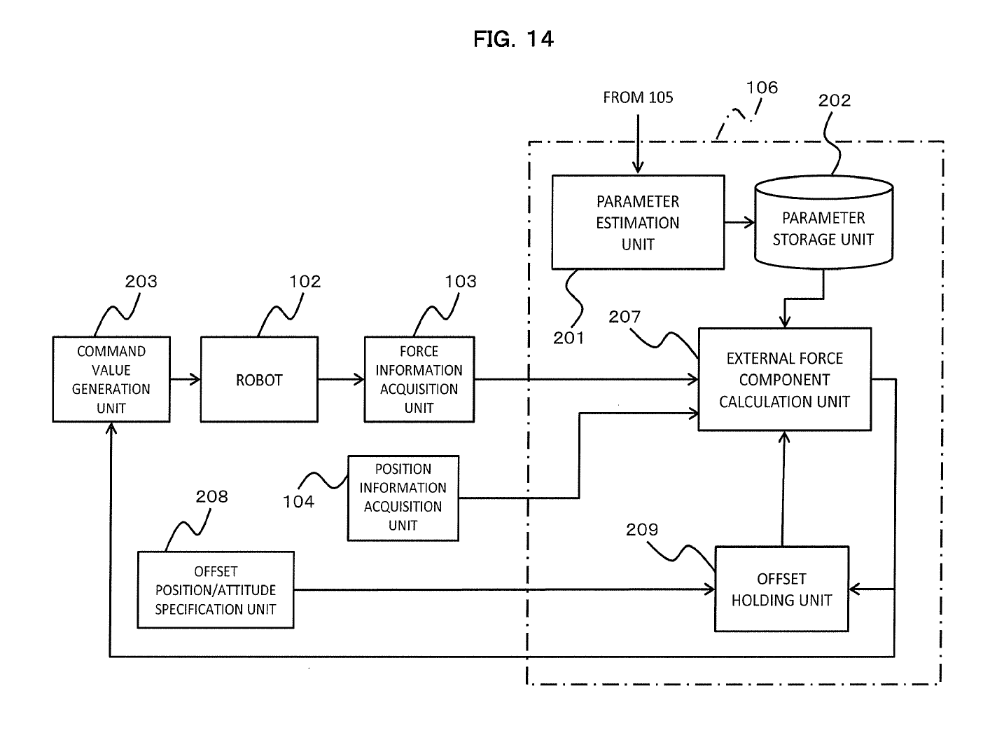

Therefore, in a third embodiment of the present invention, in order to solve this problem, as illustrated in FIG. 14, when the position P2 is reached, the user uses an offset position/attitude specification unit 208 configured to specify a command value of the position/attitude of the tool part to acquire predetermined position/attitude information, and calculation values of acting external forces calculated when the tool part moves to this position/attitude are stored in an offset holding unit 209. Moreover, the offset holding unit 209 stores calculation values of the acting external forces calculated by the external force component calculation unit 207 at this moment.

Moreover, after a control cycle subsequent to the storage of the calculation values of the work external forces, the calculation values of the acting external forces previously stored in the offset holding unit 209 are subtracted, for output, from the respective calculation values of the acting external forces that have been calculated by the external force component calculation unit 207.

Both of the calculation values of the related-art acting external forces and the calculation values of the acting external forces obtained after the offset processing of subtracting the respective calculation values of the acting external forces stored in the offset holding unit 209 are caused to flow as information in the calculation values of the acting external forces that have been calculated by the external force component calculation unit 207. As a result, when the attitude is specified by the offset position/attitude specification unit 208, only the acting external forces generated at this position can be calculated as offsets.

As described above, according to the third embodiment, it is possible to generate such a complex operation that an attitude is further changed while the contact state generated at a specific position is maintained, and generation of an operation, which has not been available up to now, can easily be implemented. As a result, the usability for the user thus significantly increases.

In other words, when the force control considering an external force component caused by an action other than the action for the calibration for the tool part is carried out, the force component can be handled as a constant external force not relating to the force control during a certain operation, and hence setting for force control involving a contact with the outside becomes very easy. As a result, the usability of the user can be increased.

The present invention can be applied to an industrial robot or a mechanical device capable of position control.

1. A calibration device, which is configured to extract, in a mechanical device configured to carry out force control of a tool part, which is mounted to a tip of the mechanical device and configured to act on a work subject, only an external force generated in the tool part by contact with the work subject, the calibration device comprising:
a position information acquisition unit configured to acquire position information on the tool part;
a force information acquisition unit configured to acquire force information on a force acting on the tool part;
a rotation axis specification unit configured to specify an arbitrary rotation axis passing through an origin of a sensor coordinate system of a sensor which acquires the force information;
an attitude generation unit configured to generate an attitude command value for rotating the tool part about the arbitrary rotation axis; and
a calibration unit configured to carry out calibration processing of subtracting a bias value and a gravity action component of a hand tip load from the force information, to thereby extract only the external force generated by the contact with the work subject,
wherein the calibration unit comprises:
an approximate curve generation unit configured to generate an approximate curve based on the position information and the force information that are obtained when the tool part is rotated in accordance with the attitude command value;
a bias value estimation unit configured to estimate the bias value of the force information based on the approximate curve, the position information, and the force information;
a mass/center-of-gravity position estimation unit configured to remove the bias value from the force information, and to calculate a mass and a center-of-gravity position vector of the hand tip load by using the force information from which the bias value is removed; and
an external force component calculation unit configured to subtract the bias value and the gravity action component of the hand tip load from the force information by using the estimated bias value, and the mass and the center-of-gravity position vector of the hand tip load.

2. The calibration device according to claim 1, wherein, when an increase amount of the force information generated by an action of an external force due to at least one of a cable and a wire mounted to the tool part exceeds a set value, the bias value estimation unit removes the force information.

3. The calibration device according to claim 1, wherein:
the calibration unit comprises:
an offset position/attitude specification unit to be used by a user to specify a command value of a position and an attitude of the tool part; and
an offset holding unit configured to store a calculation value of an acting external force calculated when the tool part is moved to the position and the attitude specified by the user; and
the calibration unit is configured to further subtract the calculation value of the acting external force held by the offset holding unit from calibration in a calculation cycle subsequent to an operation of the offset holding unit.

4. A robot system, to which the calibration device of claim 1 is applied.

5. A calibration device, which is configured to extract, in a mechanical device configured to carry out force control of a tool part, which is mounted to a tip of the mechanical device and configured to act on a work subject, only an external force generated in the tool part by contact with the work subject, the calibration device comprising:
a position information acquisition unit configured to acquire position information on the tool part;
a force information acquisition unit configured to acquire force information on a force acting on the tool part;
a rotation axis specification unit configured to specify an arbitrary rotation axis passing through an origin of a sensor coordinate system of a sensor which acquires the force information;
an attitude generation unit configured to generate an attitude command value for rotating the tool part about the arbitrary rotation axis; and
a calibration unit configured to carry out calibration processing of subtracting a bias value and a gravity action component of a hand tip load from the force information, to thereby extract only the external force generated by the contact with the work subject, based on the position information and the force information that are obtained when the tool part is rotated in accordance with the attitude command value.

6. A robot system, to which the calibration device of claim 5 is applied.
